(19) United States
(12) Patent Application Publication
(10) Pub. No.: US 2014/0305035 A1
(43) Pub. Date: Oct. 16, 2014

(54) SYSTEM FOR DRYING COAL USING SUPERHEATED STEAM

(71) Applicant: Sung Kon Kim, Seoul (KR)

(72) Inventor: Sung Kon Kim, Seoul (KR)

(73) Assignee: HANKOOK TECHNOLOGY INC, Seoul (KR)

(21) Appl. No.: 14/365,857

(22) PCT Filed: Apr. 10, 2012
(86) PCT No.: PCT/KR2012/002718

§ 371 Date: Jul. 2, 2014

(30) Foreign Application Priority Data
Dec. 15, 2011 (KR) 10-2011-0135521

(51) Int. Cl. C10L 9/08

(52) U.S. Cl. CPC C10L 9/08
USPC 44/629

(57) ABSTRACT

The present disclosure relates to a coal drying system for removing water contained in coal used as a fuel of a thermoelectric power plant with superheated steam. The system prevents the incomplete combustion of the coal by removing water existing inside and outside the coal fuel of the thermoelectric power plane, thereby improving a heating value of coal and minimizing the discharge of pollutants, prevents the corrosion of the system and improves the durability, and increases the use of low-quality coal of which the demand is low, thereby improving the stable supply of the coal.

### TECHNICAL FIELD

The present invention relates to a system for drying coal by using superheated steam, and more particularly to a coal drying system for removing water contained in coal used as a fuel of a thermoelectric power plant with superheated steam. Background Art

In general, a thermoelectric power plant generating power using coal as a fuel combusts approximately 180 ton/hr of coal to generate 500 MWs of electricity and a pulverizer supplies approximately 37 tons of coal to a boiler. Six coal storage places of a capacity of approximately 500 tons are installed in the 500 MW thermoelectric power plant, and five storage places among them regularly supply coal and one storage place is operated as a coal storing place for storing reserve coal usable for a predetermined period.

Further, it is designed that the thermoelectric power plant generating power using coal as a fuel uses 6,080 Kcal/Kg of low-moisture bituminous coal and 10% or less under the standard power design basis for coal. Several thermoelectric power plants use imported coal, some subbituminous coal of which has water content of 17% or more, so that the combustion efficiency of the boiler is deteriorated. When a heating value of used coal, of which the standard power combustion limit is 5,400 Kcal/Kg, is low, it is expected to decrease the power generation quantity and increase the fuel consumption due to the deterioration of the combustion efficiency. When high moisture and low calorie subbituminous coal is used, the water content is higher than the design basis, so that a transfer system for delivering coal is not smooth, the coal pulverization efficiency of the pulverizer is decreased, the combustion efficiency is decreased due to partially incomplete combustion, and drift of heat distribution generated in a boiler and an abnormal operation of the boiler are generated. However, the use of subbituminous coal has been gradually increased up to 41 to 60% so as to reduce fuel costs in the thermoelectric power plant.

Further, the preference for thermoelectric power plants has increased according to the expectation of international economic recovery and in the face of following the destruction by earthquake of a nuclear power plant in Japan, so that it is expected that demands and prices of coal will continuously increase. Since an environment of an international coal market has been changed from consumer-centric to supplier-centric, it is difficult to stably supply coal and output of high-calorie coal is expected to be maintained at a current level, and thus the imbalance of the coal supply and demand is expected.

A ratio of low calorie coal in the total international coal reserves is approximately 47%, meaning that the reserves of low calorie coal are high, but the low-calorie coal has low calorie and high water content to cause the combustion difficulty during the combustion. Accordingly, high moisture and low-calorie coal has been disregarded in the coal market due to the difficulty in complete combustion. Internationally, power generation has highly tended to depend on stable oil prices and the low expense of power production by nuclear power generation in recent days, but recent sharp increases in oil prices and anxiety about nuclear power have caused an increase in plans for the construction of thermoelectric power plants using coal.

A conventional technique of drying coal (thermo-dry) mainly uses a rotary drying method of drying coal particles inside a round shell with high-temperature gas while rotating the shell including coal, a flash (pneumatic) drying method of drying coal by raising high-temperature dried gas from a lower side to an upper side while supplying coal from the upper side to the lower side, and a fluid-bed drying method of drying coal by raising high-temperature dried gas together with fine particles in an upper direction.

Coal is divided into surface pollination attached to clearances between coal particles and bound pollination bound to pores inside the coal. Most of the surface pollination is water sprayed in a cleaning process in a producing area, in delivery, and in storage, a quantity of the surface pollination is determined according to a surface area and an absorptive property, a surface area of the surface pollination is increased as a particle size decreases, and capillary tubes are formed between particles to contain water so that the water content is increased. The bound pollination is formed at the generation time of the coal, and is less in an order of brown coal, soft coal (bituminous coal, subbituminous coal), and anthracite. If the coal contains much water, the heating value of coal is decreased and transport costs are increased, so that it is necessary to remove water in the process of mixing, pulverization, and separation of coal.

### DISCLOSURE OF INVENTION

### Technical Problem

Accordingly, the present invention has been made to solve the above-mentioned problems occurring in the prior art, and an object of the present invention is to improve the combustion efficiency of a boiler of a thermoelectric power plant and thus reduce an amount of fuel used by improving a heating value of coal through drying of coal with superheated steam and hot wind of a high temperature before the coal is supplied from a coal storage place to a silo and maintaining an appropriate water content of the coal.

Another object of the present invention is to provide a coal drying technique capable of preventing the generation of an environmental problem, which is caused due to incomplete combustion of coal, through a control of water contained in coal and a technique applicable to a thermoelectric power plant.

### Solution to Problem

In accordance with an aspect of the present invention, there is provided a system for drying coal using superheated steam, the system including: a superheated steam boiler for generating superheated steam by heating water supplied from a water tank with combustion of a fuel supplied from a gas tank; a high temperature air supplier for generating high temperature air by combusting the fuel supplied from the gas tank and then blowing the air; a superheated steam drying device for removing water of a surface of the coal with superheated steam supplied from the superheated steam boiler while transferring the coal, which is transferred from a coal storage place through a trough conveyor belt and arranged by an arrangement device, through a steam conveyor belt; one or more high temperature air drying devices for removing water within the coal with high temperature air supplied from the high temperature air supplier while transferring the coal passing the superheated steam drying device through a dry conveyor belt; and a natural drying device for drying the coal passing the high temperature air drying device such that water of the coal is naturally evaporated at room temperature while transferring the coal through a flat conveyor belt, to decrease a temperature of the coal.

Further, according to the present invention, the superheated steam drying device includes an electric motor for moving the steam conveyor belt, a duct installed in the steam conveyor belt to form a space for drying, and a superheated steam spray pipe for spraying the superheated steam supplied from the superheated steam boiler through a superheated steam supply pipe to an inside of the duct.

Further, according to the present invention, the one or more high temperature air drying devices include an electric motor for moving the dry conveyor belt, a duct installed in the dry conveyor belt to form a space for drying, and a high temperature air spray pipe for spraying high temperature air supplied from the high temperature air supplier through a high temperature air supply pipe to an inside of the duct, and the one or more high temperature air drying devices include multiple high temperature air drying devices stacked in a structure.

Further, according to the present invention, the natural drying device includes an electric motor for moving the flat conveyor belt and a duct installed in the flat conveyor belt to form a space for drying.

Further, according to the present invention, the duct is connected to a heat exchanger through a waste heat collecting pipe.

Further, according to the present invention, the heat exchanger separates out the heat collected from the waste heat collection pipe and pollutants, supplies the separated heat to the high temperature air supplier through a waste heat supply pipe, and supplies the separated pollutants to a cleaning device through a pollutant supply line.

Further, according to the present invention, the superheated steam boiler generates superheated steam of a pressure of 0.5 to 5 kg/cm² and a temperature of 400 to 600° C., and increases a temperature of the coal transferred through the steam conveyor belt of the superheated steam drying device to 90 to 110° C.

### Advantageous Effects of Invention

Accordingly, the method for drying coal according to the present invention may prevent the incomplete combustion of coal by removing water existing inside and outside the coal that is a fuel used in a thermoelectric power plant, so that a heating value of coal is improved, the discharge of pollutants is minimized, an anticorrosion property and a durability of a system are enhanced, a natural firing rate according to a decrease of water is decreased, the pulverization efficiency of a coal pulverizer and a heat distribution of a power generation boiler in the combustion of coal are improved, a transfer path blocking symptom during the transfer of coal is solved, and the coal supply is stably improved through the increase of the use of low-quality coal of which the demand is low. Further, the method for drying coal according to the present invention can use low-calorie coal of which a price is lower than that of high-calorie coal, reduce fuel costs and production costs through the decrease of imported coal, relatively decrease a quantity of coal consumption and thus reduce the discharge of waste and pollutants generated from combustion gas and the generation of carbon dioxide, and can be expected to replace a foreign technique and generate a market for an export of equipment overseas.

### BRIEF DESCRIPTION OF DRAWINGS

FIG. 1 is a block diagram illustrating a coal drying system using superheated steam according to the present invention;

FIG. 2 is a diagram illustrating a construction of a coal drying system using superheated steam according to the present invention;

FIG. 3 is a diagram illustrating a front surface of a coal drying apparatus according to the present invention; and

FIG. 4 is a diagram illustrating a side surface of a coal drying apparatus according to the present invention.

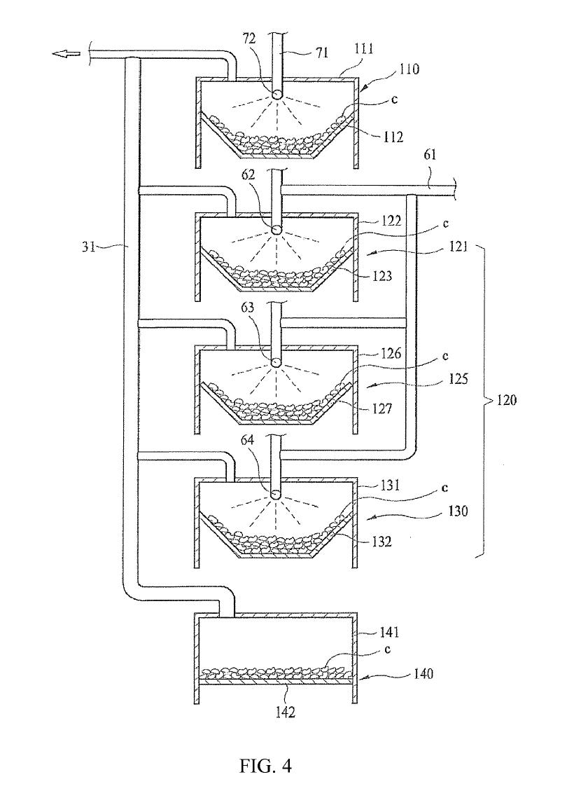

### MODE FOR THE INVENTION

Hereinafter, an exemplary embodiment of a coal drying apparatus using superheated steam according to the present invention will be described with reference to the accompanying drawings in detail.

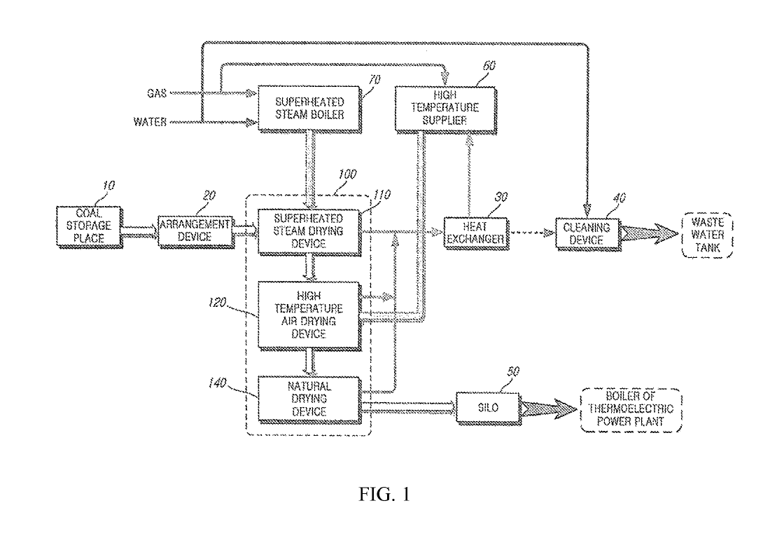

FIG. 1, a coal storage place 10 is a place for reserving and storing fuel coal of a boiler of a thermoelectric power plant. The coal includes surface pollination and inside pollination. Further, water is periodically sprayed on the coal stored in the coal storage place 10 so as to prevent coal powder from being scattered. The coal stored in the coal storage place 10 is transferred to a coal drying system through a transfer means, such as a conveyor system. In this case, the coal, from which water is not removed, stored in the coal storage place 10 may be moved to a storage tank connected with the coal drying system and stored. The coal in the coal storage place 10 is transferred to an arrangement device 20 via a plat conveyor belt 11 and a trough conveyor belt.

The arrangement device 20 evenly spreads and arranges the coal transferred from the coal storage place 10 on a steam conveyor belt 112 included in a superheated steam drying device 110 in a regular height. The arrangement device 20 arranges such that the coal is easily dried with superheated steam in the superheated steam drying device 110 when the coal transferred from the coal storage place 10 is supplied to a steam conveyor belt 112.

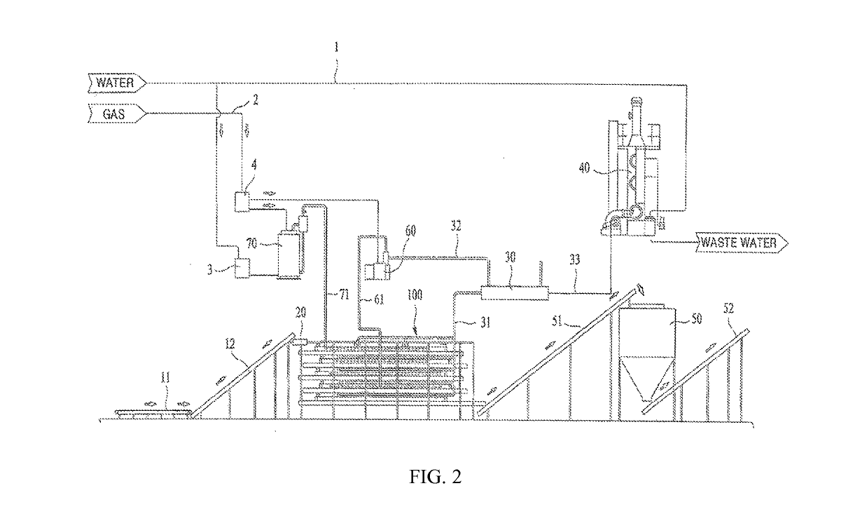

In FIG. 2, the superheated steam drying device 110, a plurality of high-temperature air drying devices 120, and a natural drying device 140, which serve as a coal drying apparatus 100 for drying the coal, are vertically installed from an upper side to a lower side. The coal drying apparatus 100 is installed inside a structure 101 provided with a plurality of frames.

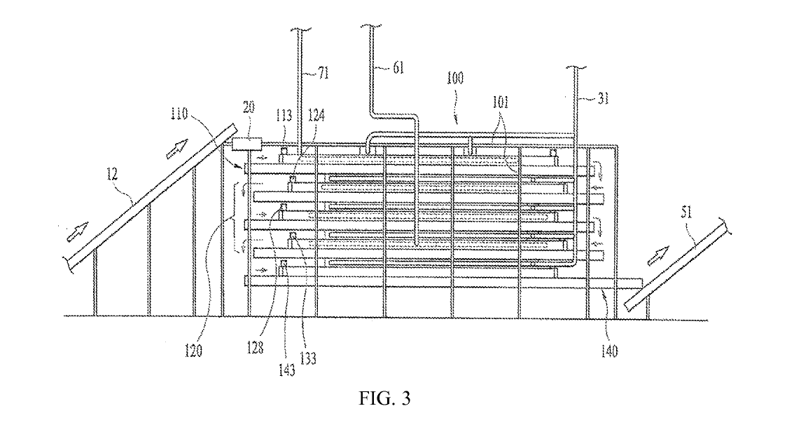

In FIG. 3, the superheated steam drying device 110 removes water at a coal surface with superheated air supplied from a superheated steam boiler 70 while transferring the coal (c) arranged in the regular height by the arrangement device 20 through the steam conveyor belt 112. A plurality of electric motors 113 for driving the steam conveyor belt 112 which is fixed to and supported by the structure 101 and transfers the coal is installed in the superheated steam drying device 110. The electric motor 112 generates power for rotating the steam conveyor belt 112 at a predetermined speed. A duct 112 for forming a space in which the coal may be dried by the superheated steam is installed in the steam conveyor belt 112. The duct 112 may be installed in an upper part of the steam conveyor belt 112 or installed such that the duct 111 passes through the steam conveyor belt 112. A superheated steam spray pipe 72 installed within the duct 111 is connected with a superheated steam supply pipe 71 for supplying the superheated steam from the superheated steam boiler 71. The superheated steam spray pipe 72 is installed such that the superheated steam supplied through the superheated steam supply pipe 71 is evenly sprayed on the surface of the coal transferred through the steam conveyor belt 112.

The high temperature air drying devices 120 dry and remove the water inside the coal (c), which is dropped after being dried with the superheated steam in the superheated steam drying device 110, with high temperature air supplied from a high temperature air supplier 60. One or more high temperature air drying devices 120 are installed. The high temperature air drying devices 120 of the present invention are installed in three stages under the superheated steam drying device 110 so that they sufficiently evaporate and remove the water inside the coal transferred through respective dry conveyor belts 123, 127, and 132. The high temperature air drying devices 120 include a first high temperature air drying device 121, a second high temperature air drying device 125, and a third high temperature air drying device 130.

The first high temperature air drying device 121 is fixed to and supported by the structure 101 under the superheated steam drying device 110. The dry conveyor belt 123 for receiving and transferring the coal (c) dropped from the steam conveyor belt 112 and a plurality of electric motors 124 for moving the dry conveyor belt 123 are installed in the first high temperature air drying device 121. The electric motor 124 generates power for rotating the dry conveyor belt 123 at a predetermined speed. A duct 122 for forming a space in which the coal (c) may be dried by the high temperature air is installed in the dry conveyor belt 123. The duct 122 may be installed in an upper side of the dry conveyor belt 123 or installed such that the duct 122 passes through the dry conveyor belt 123. A high temperature air spray pipe 62 installed inside the duct 122 is connected to a high temperature air supply pipe 61 for supplying the high temperature air from the high temperature air supplier 60. The high temperature air spray pipe 62 is installed such that the high temperature air supplied through the high temperature air supplier 60 is evenly sprayed to the coal (c) transferred through the dry conveyor belt 123.

The second high temperature air drying device 125 is fixed to and supported by the structure 101 under the first high temperature air drying device 121. The dry conveyor belt 127 for receiving and transferring the coal (c) dropped from the dry conveyor belt 123 and a plurality of electric motors 128 for moving the dry conveyor belt 127 are installed in the second high temperature air drying device 125. The electric motor 128 generates power for rotating the dry conveyor belt 127 at a predetermined speed. A duct 126 for forming a space in which the coal (c) may be dried by the high temperature air is installed in the dry conveyor belt 127. The duct 126 may be installed in an upper side of the dry conveyor belt 127 or installed such that the dry conveyor belt 127 extends through the duct 126. A high temperature air spray pipe 63 installed inside the duct 126 is connected to the high temperature air supply pipe 61 for supplying the high temperature air from the high temperature air supplier 60. The high temperature air spray pipe 63 is installed such that the high temperature air supplied from the high temperature air supplier 60 is evenly sprayed to the coal (c) transferred through the dry conveyor belt 127.

The third high temperature air drying device 130 is fixed to and supported by the structure 101 under the second high temperature air drying device 125. The dry conveyor belt 132 for receiving and transferring the coal (c) dropped from the dry conveyor belt 127 and a plurality of electric motors 133 for moving the dry conveyor belt 132 are installed in the third high temperature air drying device 130. The electric motor 133 generates power for rotating the dry conveyor belt 132 at a predetermined speed. A duct 131 for forming a space in which the coal (c) may be dried by the high temperature air is installed in the dry conveyor belt 132. The duct 131 may be installed in an upper side of the dry conveyor belt 132 or installed such that the dry conveyor belt 132 extends through the duct 131. A high temperature air spray pipe 64 installed inside the duct 131 is connected to a high temperature air supply pipe 61 for supplying the high temperature air from the high temperature air supplier 60. The high temperature air spray pipe 64 is installed such that the high temperature air supplied from the high temperature air supplier 60 is evenly sprayed on the coal (c) transferred through the dry conveyor belt 132.

The natural drying device 140 dries the coal (c) at room temperature such that the water of the coal (c) is naturally evaporated and decreases a temperature of the coal (c) while transferring the coal (c) which is dried with the high temperature air through passing of the multi-staged high temperature air drying devices 120 and dropped to the flat conveyor belt 142. The natural drying device 140 is fixed to and supported by the structure 101 under the third high temperature air drying device 130. The flat conveyor belt 142 for receiving and transferring the coal (c) dropped from the dry conveyor belt 132 and a plurality of electric motors 143 for transferring the flat conveyor belt 142 are installed in the natural drying device 140. The electric motor 143 generates power for rotating the flat conveyor belt 142 at a predetermined speed. A duct 141 for forming a space in which the coal (c) may be naturally dried at room temperature or lower is installed in the flat conveyor belt 142. The duct 141 may be installed in an upper side of the flat conveyor belt 142 or installed such that the flat conveyor belt 142 extends through the duct 141. The compulsory air blowing may be performed such that the air of room temperature is supplied to inside the duct 141. The installation of the duct 141 may be omitted, but the duct may be installed so as to prevent dust generated from the dried coal from being scattered to the outside.

The coal dried through the natural evaporation in the natural drying device 140 is-supplied to the silo 50 via the trough conveyor belt 51 and stored in the silo 50, and the dried coal stored in the silo 50 is supplied to the boiler of the thermoelectric power plant via the trough conveyor belt 52.

The respective ducts 111, 122, 126, 131, and 141 of the superheated steam drying device 110, the high temperature air drying devices 120, and the natural drying device 140 are connected to a waste heat collecting pipe 31 so that high-temperature waste heat generated within the ducts may be collected in a heat exchanger 30. The heat exchanger 30 separates out the heat collected through the waste heat collecting pipe 31 and pollutants including dust. The heat separated by the heat exchanger 30 may be-supplied to the high temperature air supplier 60 via a waste heat supply pipe 32 and combined with the high temperature air generated in the high temperature air supplier 60. The high temperature air supplier 60 may reduce necessary fuels used for reheating the heat collected in the heat exchanger 30 to high temperature air. The pollutants separated by the heat exchanger 30 may be supplied to a cleaning device 40 through a pollutant supply line 33, water-processed in the cleaning device, and then discharged as waste water. The cleaning device 40 cleans the pollutants introduced from the heat exchanger 30 with water so that the dust is discharged as waste water together with water and cleaned air is discharged to the outside.

The superheated steam boiler 70 heats water supplied from a water tank 3 with a fuel supplied from a gas tank 4 and generates the superheated steam. The superheated steam boiler 70 generates superheated steam of a low pressure of 0.5 to 5 kg/cm² and a high temperature of 400 to 600° C. The superheated steam boiler 70 generates superheated steam at 300 Kg per hour. The superheated steam boiler 70 may increase a temperature of the coal transferred through the steam conveyor belt 112 of the superheated steam drying device 110 up to 90 to 110° C. A spontaneous combustion temperature of coal is approximately 93 to 95° C., but the superheated steam of 400 to 600° C. contains rarefied oxygen, so that it does not cause the coal to combust. The superheated steam is transparent gas in which evaporation latent heat that is gasification heat is combined with condensation heat transfer and radiant and conductive heat generated by heating sensible heat. The superheated steam is generated by heating saturated steam generated in the boiler with a heater. The superheated steam generated in the boiler for the power generation is of high pressure and high temperature, but the superheated steam generated in the superheated steam boiler is of lower pressure and low temperature. The superheated steam is generated by heating water of room temperature, so that a quantity of dissolved oxygen in water is several ppms. Accordingly, if the superheated steam is not combined with air, the superheated steam may be heat-treated in a non-oxygen state, and its capability for transferring heat and its drying performance are very excellent due to its high potential calorie characteristic. A heat processing capability of the superheated steam is approximately 10 times better than the hot wind, i.e. the high temperature air. Accordingly, the superheated steam is effective to absorb the latent heat within the coal.

The high temperature air supplier 60 heats the air to a high temperature with the fuel supplied from the gas tank 4 and then blows and supplies the heated air. The high temperature air supplier 60 approximately generates only 10 Kcal per hour.

The coal drying system using the superheated steam having the aforementioned elements according to the present invention transfers the coal stored in the coal storage place 10 to a device for drying the coal through the conveyor belt for horizontally transferring the coal or the conveyor belt for raising the coal up to a predetermined height and transferring the coal. The coal transferred to an inlet of the device for drying the coal is introduced on the steam conveyor belt 112 of the superheated steam drying device 110 in a state of being evenly spread according to the passing of the arrangement device 20.

The coal introduced on the steam conveyor belt 112 is transferred to an inside of the duct 111. In the duct 111, the low pressure and high temperature superheated steam supplied through the superheated steam supply pipe 71 from the superheated steam boiler 70 is sprayed to the coal from the superheated steam spray pipe 72, so that the water on the coal surface is removed.

The coal transferred to an end of the steam conveyor belt 112 of the superheated steam drying device 110 is dropped on to the dry conveyor belt 123 of the first high temperature air drying device 121 due to gravity. The coal dropped on to the dry conveyor belt 123 of the first high temperature air drying device 121 is transferred to an inside of the duct 122. The high temperature hot wind supplied from the high temperature air supplier 60 through the high temperature air supply pipe 61 is sprayed on the coal (c) from the high temperature air spray pipe 62 within the duct 122, so that the water inside the coal is removed. Further, the coal transferred to an end of the dry conveyor belt 123 of the first high temperature air drying device 121 is dropped on to the dry conveyor belt 127 of the second high temperature air drying device 125 due to gravity, so that the high temperature hot wind secondly removes the water inside the coal while the coal passes through the duct 126 of the second high temperature air drying device 125. Further, the coal transferred to an end of the dry conveyor belt 127 of the second high temperature air drying device 125 is dropped on to the dry conveyor belt 132 of the third high temperature air drying device 130 due to gravity, so that the high temperature hot wind thirdly removes the water inside the coal while the coal passes through the duct 131 of the third high temperature air drying device 130.

Further, the coal transferred to an end of the dry conveyor belt 132 of the third high temperature air drying device 130 is dropped on to the flat conveyor belt 142 of the natural drying device 40 due to gravity. The coal dropped on to the flat conveyor belt 142 of the natural drying device 40 is transferred to an inside of the duct 141 and the water inside the coal is naturally evaporated at room temperature within the duct 141, so that a temperature of the coal becomes low.

The steam conveyor belt 112 of the superheated steam drying device 110, the respective dry conveyor belts 123, 127, and 132 of the plurality of high temperature air drying devices 121, 125, and 130, and the flat conveyor belt 142 of the natural drying device 140 are horizontally installed, respectively, and the conveyor belts are positioned up and down while having a predetermined interval. Further, an inlet of the dry conveyor belt 123 of the first high temperature air drying device 121 protrudes more than an outlet of the steam conveyor belt 112 of the superheated steam drying device 110, an inlet of the dry conveyor belt 127 of the second high temperature air drying device 125 protrudes more than an outlet of the dry conveyor belt 123 of the first high temperature air drying device 121, and an inlet of the dry conveyor belt 132 of the third high temperature air drying device 130 protrudes more than an outlet of the dry conveyor belt 127 of the second high temperature air drying device 125. Further, the inlet of the trough conveyor belt 51 connected to the silo 50 protrudes in a lower side of the outlet of the flat conveyor belt 142 of the natural drying device 140. That is, an inlet and an outlet of the trough conveyor belt 51 installed between the natural drying device 140 and the silo 50 are positioned in a lower side of the natural drying device 140 and an upper side of the silo 50, respectively. Further, the trough conveyor belt 52 is connected between the outlet of the silo 50 and the boiler of the thermoelectric power plant.

The superheated steam after the removal of the water of the coal surface within the duct 111 of the superheated steam drying device 110, the high temperature air after the removal of the water within the coal in the ducts 122, 126, and 131 of the plurality of high temperature air drying devices 121, 125, and 130, and the heat generated from the coal during the natural evaporation in the duct 141 of the natural drying device 140 are collected in the heat exchanger 30 through the waste heat collecting pipe 31. The heat exchanger 30 heat exchanges the collected waste heat, and the heat-exchanged waste heat is then re-circulated to the high temperature air supplier 60 via the waste heat supply pipe 32. The waste heat heat-exchanged by the heat exchanger 30 and the pollutants including dust separated from the coal are transferred to the cleaning device 40 via the pollutant supply line 33. The cleaning device 40 cleans and absorbs the pollutants with water such that the pollutants are processed as the waste water again, and discharges the air from which the pollutants are removed to the air.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A system for drying coal using superheated steam, the system comprising:
a superheated steam boiler for generating superheated steam by heating water supplied from a water tank with combustion of a fuel supplied from a gas tank
a high temperature air supplier for generating high temperature air by combusting the fuel supplied from the gas tank and then blowing the air a superheated steam drying device for removing water of a surface of the coal with superheated steam supplied from the superheated steam boiler while transferring the coal, which is transferred from a coal storage place through a trough conveyor belt and arranged by an arrangement device, through a steam conveyor belt;
one or more high temperature air drying devices for removing water within the coal with high temperature air supplied from the high temperature air supplier while transferring the coal passing the superheated steam drying device through a dry conveyor belt; and
a natural drying device for drying the coal passing the high temperature air drying device such that water of the coal is naturally evaporated at room temperature while transferring the coal through a flat conveyor belt, to decrease a temperature of the coal.

2. The system as claimed in claim 1, wherein the superheated steam drying device comprises an electric motor for moving the steam conveyor belt, a duct installed in the steam conveyor belt to form a space for drying, and a superheated steam spray pipe for spraying the superheated steam supplied from the superheated steam boiler through a superheated steam supply pipe to an inside of the duct.

3. The system as claimed in claim 1, wherein the one or more high temperature air drying devices comprise an electric motor for moving the dry conveyor belt, a duct installed in the dry conveyor belt to form a space for drying, and a high temperature air spray pipe for spraying high temperature air supplied from the high temperature air supplier through a high temperature air supply pipe to an inside of the duct, and the one or more high temperature air drying devices comprise multiple high temperature air drying devices stacked in a structure.

4. The system as claimed in claim 1, wherein the natural drying device comprises an electric motor for moving the flat conveyor belt and a duct installed in the flat conveyor belt to form a space for drying.

5. The system as claimed in claim 2, wherein the duct is connected to a heat exchanger through a waste heat collecting pipe.

6. The system as claimed in claim 5, wherein the heat exchanger separates out the heat collected from the waste heat collection pipe and pollutants, supplies the separated heat to the high temperature air supplier through a waste heat supply pipe, and supplies the separated pollutants to a cleaning device through a pollutant supply line.

7. The system as claimed in claim 1, wherein the superheated steam boiler generates superheated steam of a pressure of 0.5 to 5 kg/cm² and a temperature of 400 to 600° C., and increases a temperature of the coal transferred through the steam conveyor belt of the superheated steam drying device to 90 to 110° C.

8. The system as claimed in claim 3, wherein the duct is connected to a heat exchanger through a waste heat collecting pipe.

9. The system as claimed in claim 4, wherein the duct is connected to a heat exchanger through a waste heat collecting pipe.
